(19) United States
(12) Patent Application Publication
(10) Pub. No.: US 2020/0067372 A1
(43) Pub. Date: Feb. 27, 2020

(54) MOTOR, BLOWER APPARATUS, AND VACUUM CLEANER

(71) Applicant: Nidec Corporation, Kyoto (JP)

(72) Inventor: Shota IKENO, Kyoto (JP)

(21) Appl. No.: 16/535,179

(22) Filed: Aug. 8, 2019

(30) Foreign Application Priority Data
Aug. 27, 2018 (JP) 2018-158631

(51) Int. Cl. H02K 5/173; F16C 35/067; H02K 5/14; A47L 5/12; H02K 5/124

(52) U.S. Cl. CPC H02K 5/1732; F16C 35/067; F16C 33/72; A47L 5/12; H02K 5/124; H02K 5/14

(57) ABSTRACT

A motor includes a rotor including a shaft that is disposed along a central axis extending vertically, a stator disposed to face the rotor in a radial direction, a first bearing that is disposed above the stator and supports the rotor so as to be rotatable about the central axis with respect to the stator, and a motor housing that houses at least a portion of the stator. The motor housing includes a first cylindrical portion that is disposed radially outward of the first bearing, extends downward, and has a cylindrical shape, a first top plate portion that extends radially inward from a lower end of the first cylindrical portion, and a second cylindrical portion that extends downward from a radially inner end of the first top plate portion and includes a cylindrical shape. The radially inner surface of the second cylindrical portion is positioned such that a gap is defined between the radially inner surface of the second cylindrical portion and the radially outer surface of the shaft in the radial direction.

### CROSS REFERENCE TO RELATED APPLICATION

The present invention claims priority under 35 U.S.C. § 119 to Japanese Application No. 2018-158631 filed on Aug. 27, 2018, the entire contents of which application is hereby incorporated herein by reference.

### 1. Field of the Invention

The present disclosure relates to a motor, a blower apparatus, and a vacuum cleaner.

### 2. Background

A conventional rolling bearing is disclosed as a bearing for rotatably supporting a rotor of a motor. In the rolling bearing, a seal is attached between inner and outer rings. The rolling bearing described above has an annular shield plate mounted on at least one of the inner and outer rings on the axially outer side of the seal, the shield plate facing the seal with a gap therebetween and covering the seal. Thus, the waterproofness and dust resistance of the rolling bearing can be improved.

The conventional rolling bearing has a problem of being expensive. When the above-described conventional rolling bearing is applied to a motor in order to improve the dust resistance of the bearing of the motor, the cost of the motor may be increased.

### SUMMARY

A motor according to an example embodiment of the present disclosure includes a rotor including a shaft that is disposed along a central axis extending vertically, a stator disposed to face the rotor in a radial direction, a first bearing that is disposed above the stator and supports the rotor so as to be rotatable about the central axis with respect to the stator; and a motor housing that houses at least a portion of the stator. The motor housing includes a first cylindrical portion that is disposed radially outward of the first bearing, extends downward, and has a cylindrical shape, a first top plate portion that extends radially inward from a lower end of the first cylindrical portion, and a second cylindrical portion that extends downward from a radially inner end of the first top plate portion and has a cylindrical shape. The radially inner surface of the second cylindrical portion is positioned such that a gap is defined between the radially inner surface of the second cylindrical portion and the radially outer surface of the shaft in the radial direction.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is an overall perspective view of an example of a motor according to an example embodiment of the present disclosure.

FIG. 2 is a perspective view showing a longitudinal section of a motor according to an example embodiment of the present disclosure.

FIG. 3 is a longitudinal sectional view of a motor according to an example embodiment of the present disclosure.

FIG. 4 is a partial longitudinal sectional view showing an area around a first bearing of the motor.

FIG. 5 is a partial longitudinal sectional view showing an area around a second bearing of the motor.

FIG. 6 is a longitudinal sectional view of a motor according to a first modification of an example embodiment of the present disclosure.

FIG. 7 is a partial longitudinal sectional view showing an area around a first bearing of the motor according to the first modification of an example embodiment of the present disclosure.

FIG. 8 is a partial longitudinal sectional view showing an area around a second bearing of the motor according to the first modification of an example embodiment of the present disclosure.

FIG. 9 is a partial longitudinal sectional view showing an area around a second bearing of a motor according to a second modification of an example embodiment of the present disclosure.

FIG. 10 is a longitudinal sectional view of a blower apparatus according to an example embodiment of the present disclosure.

FIG. 11 is a perspective view of a vacuum cleaner according to an example embodiment of the present disclosure.

### DETAILED DESCRIPTION

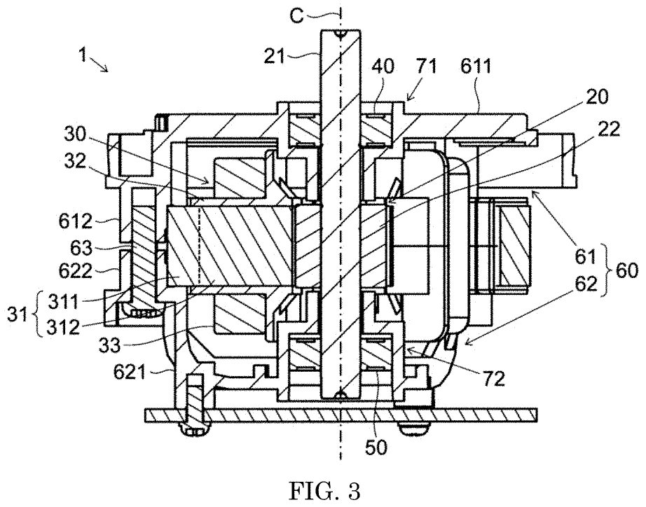

Hereinafter, example embodiments of the present disclosure will be described in detail with reference to the accompanying drawings. It is assumed herein that: a direction in which a central axis of a motor extends is referred to simply by the term “axial direction”, “axial”, or “axially”; a direction perpendicular to the central axis of the motor with respect to the central axis of the motor is referred to simply by the term “radial direction”, “radial”, or “radially”; and a direction along a circular arc around the central axis of the motor is referred to simply by the term “circumferential direction”, “circumferential”, or “circumferentially”. A central axis of a blower apparatus coincides with the central axis of the motor. It is also assumed herein that, for the sake of convenience of description, an axial direction is defined as a vertical direction, and the shape of each member or portion and relative positions of different members or portions will be described on the assumption that a vertical direction and upper and lower sides in FIGS. 3, 6, and 10 are a vertical direction and upper and lower sides of the motor and the blower apparatus. The “upper side” of the motor and the blower apparatus is an “intake side” and the “lower side” is an “exhaust side”. It should be noted, however, that the above definition of the vertical direction and the upper and lower sides is not intended to restrict the orientation of, or relative positions of different members or portions of, the motor and the blower apparatus when in use.

It is also assumed herein that, regarding a vacuum cleaner, the shape of each member or portion and relative positions of different members or portions will be described with the direction approaching the floor surface being referred to by the term “lower” or “downward”, and the direction away from the floor surface being referred to by the term “upper” or “upward”. It should be noted, however, that the above definition of the directions is not intended to restrict the orientation of, or relative positions of different members or portions of, the vacuum cleaner when in use. In addition, the positional relationship may be described using the terms “upstream side” and “downstream side”, regarding the direction of flow of air flowing from the intake side to the exhaust side when the blower apparatus is driven. It is also assumed herein that a section parallel to the axial direction is referred to as a “longitudinal section”. Note that the wordings “parallel” and “at right angles” as used herein include not only “exactly parallel” and “exactly at right angles”, respectively, but also “substantially parallel”, and “substantially at right angles”, respectively.

### 1. Configuration of Motor

### 1-1. Schematic Configuration of Motor

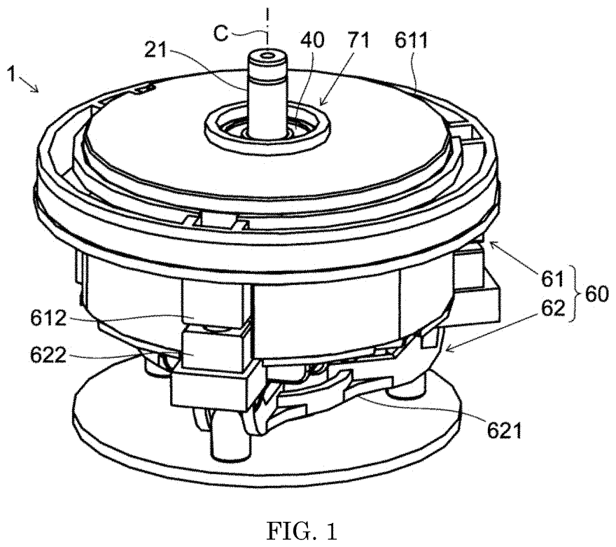

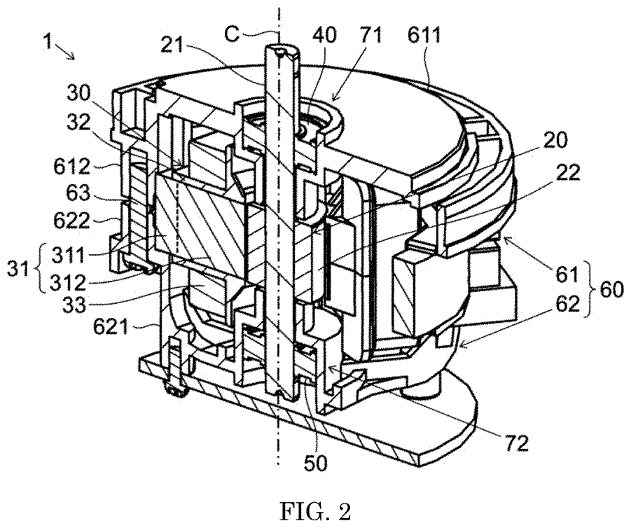

FIG. 1 is an overall perspective view of an example of a motor 1 according to an example embodiment of the present disclosure. FIG. 2 is a perspective view showing a longitudinal section of the motor 1 according to the example embodiment of the present disclosure. FIG. 3 is a longitudinal sectional view of the motor 1 according to the example embodiment of the present disclosure. The motor 1 has a rotor 20, a stator 30, a first bearing 40, and a motor housing 60. The motor 1 further has a second bearing 50.

The rotor 20 is disposed radially inward of the stator 30. The rotor 20 includes a shaft 21 disposed along a vertically extending central axis C. The shaft 21 is a vertically extending columnar member made of, for example, metal. The rotor 20 further includes a rotor magnet 22. The rotor magnet 22 is cylindrical and is fixed to the shaft 21 inserted into the rotor magnet 22.

The stator 30 is disposed radially outward of the rotor 20. The stator 30 is disposed to face the rotor 20 in the radial direction. The stator 30 includes a stator core 31, an insulator 32, and a coil 33.

The stator core 31 includes a core back 311 and a plurality of teeth 312. The core back 311 is annular around the central axis C. The plurality of teeth 312 extend radially inward from the inner peripheral surface of the core back 311. The plurality of teeth 312 are arranged at predetermined intervals in the circumferential direction. The stator core 31 may be constructed by joining a plurality of core pieces. The stator core 31 may be constructed by vertically laminating a plurality of electromagnetic steel plates.

The insulator 32 is disposed on the stator core 31. The insulator 32 is provided to surround the outer surfaces of the teeth 312. The insulator 32 is disposed between the stator core 31 and the coil 33. The insulator 32 is made of, for example, an insulating member such as a resin. Portions of the teeth 312 facing the rotor magnet 22 are exposed from the insulator 32.

The coil 33 is formed of a conductive wire wound around the insulator 32 in each of the plurality of teeth 312. That is, the insulator 32 is interposed between the teeth 312 and the coils 33. The teeth 312 and the coils 33 are electrically insulated from each other by the insulator 32. The plurality of coils 33 are arranged at predetermined intervals in the circumferential direction.

The first bearing 40 and the second bearing 50 are arranged in pairs in the axial direction. The first bearing 40 is disposed above the stator 30 and supports the rotor 20 so as to be rotatable about the central axis C with respect to the stator 30. The second bearing 50 is disposed below the stator 30 and supports the rotor 20 so as to be rotatable about the central axis C with respect to the stator 30. The first bearing 40 and the second bearing 50 are fixed to the motor housing 60. The shaft 21 is fixed to the inside of the first bearing 40 and the inside of the second bearing 50. That is, the first bearing 40 and the second bearing 50 support the shaft 21 so as to be rotatable about the central axis C with respect to the motor housing 60. The first bearing 40 and the second bearing 50 are rolling bearings, for example.

The motor housing 60 houses at least a part of the stator 30. The motor housing 60 has an upper housing 61 and a lower housing 62.

The upper housing 61 includes an upper plate 611, a plurality of upper connection portions 612, and an upper bearing holding portion 71. The upper plate 611 has a disk shape that extends in the radial direction about the central axis C. The plurality of upper connection portions 612 extend axially downward from the radially outer end of the upper plate 611. The plurality of upper connection portions 612 are arranged at predetermined intervals in the circumferential direction. The upper bearing holding portion 71 is disposed on the upper plate 611 near the central axis C and at the central part of the upper plate 611. The shaft 21 vertically penetrates the central part of the upper bearing holding portion 71. The first bearing 40 is held on the inner surface of the upper bearing holding portion 71. The detailed configuration of the upper bearing holding portion 71 will be described later.

The lower housing 62 includes a frame portion 621, a plurality of lower connection portions 622, and a lower bearing holding portion 72. The frame portion 621 is in the shape of a rod radially extending in a radial pattern about the central axis C. The plurality of lower connection portions 622 respectively extend axially upward from one radially outer end of the frame portion 621. The plurality of lower connection portions 622 are arranged at predetermined intervals in the circumferential direction. The lower bearing holding portion 72 is disposed on the frame portion 621 near the central axis C and at the central part of the frame portion 621. The shaft 21 vertically penetrates the central part of the lower bearing holding portion 72. The second bearing 50 is held on the inner surface of the lower bearing holding portion 72. The detailed configuration of the lower bearing holding portion 72 will be described later.

The plurality of upper connection portions 612 and the plurality of lower connection portions 622 face and are adjacent to each other in the axial direction. Fixing members 63 which are, for example, screws are attached to the upper connection portions 612 and the lower connection portions 622. The upper housing 61 and the lower housing 62 are connected and fixed by the fixing members 63.

In the motor 1 configured as described above, when a drive current is supplied to the coils 33, a magnetic flux in the radial direction is generated in the stator core 31. A magnetic field generated by the magnetic flux of the stator 30 and a magnetic field generated by the rotor magnet 22 act to generate torque in the circumferential direction of the rotor 20. The torque causes the rotor 20 to rotate about the central axis C.

### 1-2. Detailed Configuration Around First Bearing of Motor

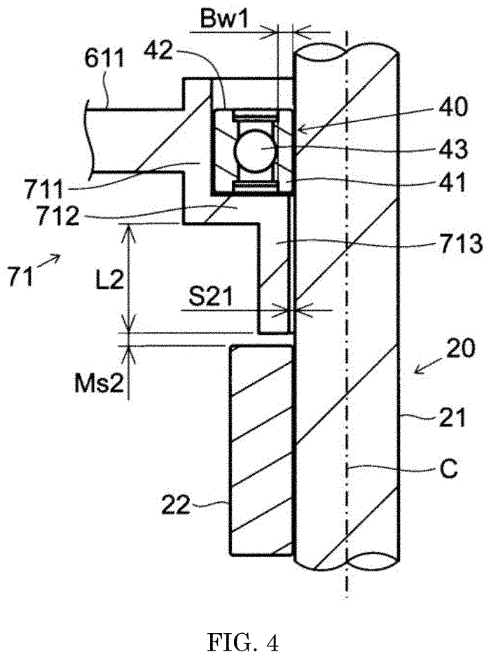

FIG. 4 is a partial longitudinal sectional view showing an area around the first bearing 40 of the motor 1. The upper bearing holding portion 71 includes a first cylindrical portion 711, a first top plate portion 712, and a second cylindrical portion 713. That is, the motor housing 60 includes the first cylindrical portion 711, the first top plate portion 712, and the second cylindrical portion 713.

The first cylindrical portion 711 is disposed radially outward of the first bearing 40. The first cylindrical portion 711 has a cylindrical shape extending downward. In the present example embodiment, the first cylindrical portion 711 is disposed at the radially inner edge of the upper plate 611. Further, the first cylindrical portion 711 extends downward from the upper end of the motor housing 60. The first cylindrical portion 711 is open at the top in the axial direction. The first bearing 40 is fixed to the inner surface of the first cylindrical portion 711. The first cylindrical portion 711 faces the first bearing 40 in the radial direction.

The first top plate portion 712 extends radially inward from the lower end of the first cylindrical portion 711. The first top plate portion 712 has a disk shape that extends in the radial direction about the central axis C. The first top plate portion 712 is disposed below the first bearing 40. The first top plate portion 712 closely faces the first bearing 40 in the axial direction.

The second cylindrical portion 713 has a cylindrical shape extending downward from the radially inner end of the first top plate portion 712. The second cylindrical portion 713 is disposed radially outward of the shaft 21. The second cylindrical portion 713 faces the shaft 21 in the radial direction. The radially inner surface of the second cylindrical portion 713 faces the radially outer surface of the shaft 21 with a gap S21 therebetween.

According to the above configuration, a labyrinth structure can be formed around the first bearing 40 by the gap S21. That is, dust in the motor housing 60 can be prevented from reaching the first bearing 40. Further, due to the formation of the labyrinth structure, the flow of air flowing between the inside and the outside of the motor housing 60 via the first bearing 40 is suppressed. Therefore, in the other example embodiments, even when air flows from the outside to the inside of the motor housing 60 via the first bearing 40, dust outside the motor housing 60 can be prevented from reaching the first bearing 40. Therefore, dust resistance of the first bearing 40 can be improved by an inexpensive configuration.

The first bearing 40 has an inner ring 41, an outer ring 42, and rolling elements 43. The gap S21 between the second cylindrical portion 713 and the shaft 21 in the radial direction closely faces the inner ring 41 of the first bearing 40 in the axial direction. The gap S21 between the second cylindrical portion 713 and the shaft 21 in the radial direction is narrower than the width Bw1 of the inner ring 41 of the first bearing 40 in the radial direction. This configuration can prevent dust from reaching an area between the inner ring 41 and the outer ring 42 of the first bearing 40. Therefore, the dust resistance of the first bearing 40 can be further enhanced.

The rotor 20 is provided with the rotor magnet 22. The rotor magnet 22 is fixed to the radially outer surface of the shaft 21. The second cylindrical portion 713 is disposed above the rotor magnet 22. The second cylindrical portion 713 closely faces the rotor magnet 22 in the axial direction. A gap Ms2 between the lower end of the second cylindrical portion 713 and the upper end of the rotor magnet 22 in the axial direction is shorter than the length L2 of the second cylindrical portion 713 in the axial direction. This configuration can prevent dust in the motor housing 60 from entering the gap Ms2 between the second cylindrical portion 713 and the rotor magnet 22 in the axial direction. Therefore, intrusion of dust into the first bearing 40 from the gap Ms2 between the second cylindrical portion 713 and the rotor magnet 22 in the axial direction can be prevented.

### 1-3. Detailed Configuration Around Second Bearing of Motor

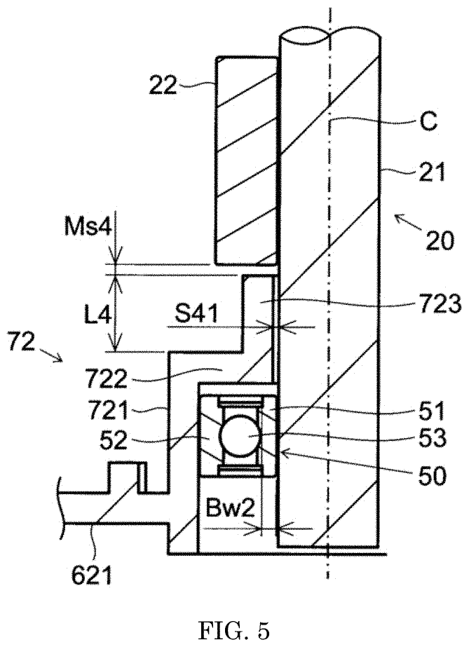

FIG. 5 is a partial longitudinal sectional view showing an area around the second bearing 50 of the motor 1. The lower bearing holding portion 72 includes a third cylindrical portion 721, a third top plate portion 722, and a fourth cylindrical portion 723. That is, the motor housing 60 includes the third cylindrical portion 721, the third top plate portion 722, and the fourth cylindrical portion 723.

The third cylindrical portion 721 is disposed radially outward of the second bearing 50. The third cylindrical portion 721 has a cylindrical shape extending upward. In the present example embodiment, the third cylindrical portion 721 is disposed at the radially inner edge of the lower housing 62. The third cylindrical portion 721 extends upward from the lower end of the motor housing 60. The third cylindrical portion 721 is open at the bottom in the axial direction. The second bearing 50 is fixed to the inner surface of the third cylindrical portion 721. The third cylindrical portion 721 radially faces the second bearing 50.

The third top plate portion 722 extends radially inward from the upper end of the third cylindrical portion 721. The third top plate portion 722 has a disk shape extending in the radial direction about the central axis C. The third top plate portion 722 is disposed above the second bearing 50. The third top plate portion 722 closely faces the second bearing 50 in the axial direction.

The fourth cylindrical portion 723 has a cylindrical shape extending upward from the radially inner end of the third top plate portion 722. The fourth cylindrical portion 723 is disposed radially outward of the shaft 21. The fourth cylindrical portion 723 faces the shaft 21 in the radial direction. The radially inner surface of the fourth cylindrical portion 723 faces the radially outer surface of the shaft 21 with a gap S41 therebetween.

According to the above configuration, a labyrinth structure can be formed around the second bearing 50 by the gap S41. That is, dust in the motor housing 60 can be prevented from reaching the second bearing 50. Further, due to the formation of the labyrinth structure, the flow of air flowing between the inside and the outside of the motor housing 60 via the second bearing 50 is suppressed. Therefore, in the other example embodiments, even when air flows from the outside to the inside of the motor housing 60 via the second bearing 50, dust outside the motor housing 60 can be prevented from reaching the second bearing 50. Therefore, dust resistance of the second bearing 50 can be improved by an inexpensive configuration.

The second bearing 50 has an inner ring 51, an outer ring 52, and rolling elements 53. The gap S41 between the fourth cylindrical portion 723 and the shaft 21 in the radial direction closely faces the inner ring 51 of the second bearing 50 in the axial direction. The gap S41 between the fourth cylindrical portion 723 and the shaft 21 in the radial direction is narrower than the width Bw2 of the inner ring 51 of the second bearing 50 in the radial direction. This configuration can prevent dust from reaching an area between the inner ring 51 and the outer ring 52 of the second bearing 50. Therefore, the dust resistance of the second bearing 50 can be further enhanced.

The rotor magnet 22 is fixed to the radially outer surface of the shaft 21. The fourth cylindrical portion 723 is disposed below the rotor magnet 22. The fourth cylindrical portion 723 closely faces the rotor magnet 22 in the axial direction. A gap Ms4 between the upper end of the fourth cylindrical portion 723 and the lower end of the rotor magnet 22 in the axial direction is shorter than the length L4 of the fourth cylindrical portion 723 in the axial direction. This configuration can prevent dust in the motor housing 60 from entering the gap Ms4 between the fourth cylindrical portion 723 and the rotor magnet 22 in the axial direction. Therefore, intrusion of dust into the second bearing 50 from the gap Ms4 between the fourth cylindrical portion 723 and the rotor magnet 22 in the axial direction can be prevented.

### 1-4. First Modification of Motor

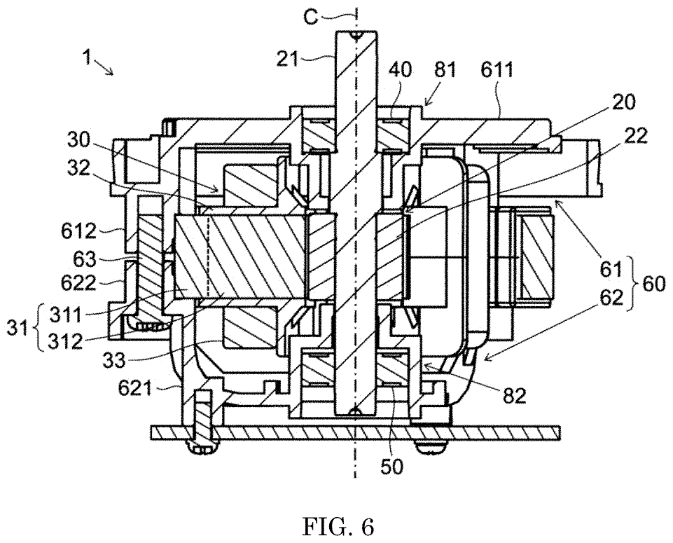

FIG. 6 is a longitudinal sectional view of a motor 1 according to a first modification. The motor 1 according to the first modification has a first bearing 40, a second bearing 50, and a motor housing 60. The motor housing 60 includes an upper bearing holding portion 81 and a lower bearing holding portion 82.

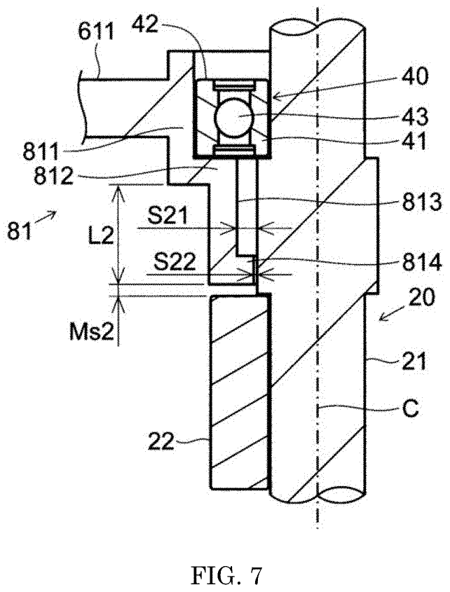

FIG. 7 is a partial longitudinal sectional view showing an area around the first bearing 40 of the motor 1 according to the first modification. The upper bearing holding portion 81 includes a first cylindrical portion 811, a first top plate portion 812, and a second cylindrical portion 813. The configurations of the first cylindrical portion 811, the first top plate portion 812, and the second cylindrical portion 813 are substantially the same as those of the first cylindrical portion 711, the first top plate portion 712, and the second cylindrical portion 713 described above with reference to FIG. 4, and therefore, the description thereof will be omitted.

The upper bearing holding portion 81 further includes a second top plate portion 814. That is, the motor housing 60 further includes the second top plate portion 814. The second top plate portion 814 extends radially inward from the lower end of the second cylindrical portion 813. The second top plate portion 814 has a disk shape extending in the radial direction about the central axis C. The second top plate portion 814 is disposed radially outward of the shaft 21. The second top plate portion 814 faces the shaft 21 in the radial direction. A gap S22 between the second top plate portion 814 and the shaft 21 in the radial direction is narrower than the gap S21 between the second cylindrical portion 813 and the shaft 21 in the radial direction.

According to the configuration of the first modification, it is not necessary to control the gap S21 between the second cylindrical portion 813 and the shaft 21 in the radial direction with high accuracy throughout the entire region of the second cylindrical portion 813 in the axial direction. Therefore, dust resistance of the first bearing 40 can be improved by an inexpensive configuration, and productivity of the motor housing 60 can be increased.

The second cylindrical portion 813 is disposed above the rotor magnet 22. The second cylindrical portion 813 closely faces the rotor magnet 22 in the axial direction. The outer diameter of the second cylindrical portion 813 is larger than the outer diameter of the rotor magnet 22. That is, the radially outer surface of the second cylindrical portion 813 is disposed radially outward of the radially outer surface of the rotor magnet 22.

According to the configuration described above, dust moving from top to bottom at the radially outer side of the gap Ms2 between the second cylindrical portion 813 and the rotor magnet 22 in the radial direction, for example, is likely to move downward on the radially outer side of the rotor magnet 22 without moving toward the radially inner side along the top surface of the rotor magnet 22. That is, intrusion of dust into the gap Ms2 between the second cylindrical portion 813 and the rotor magnet 22 in the axial direction can be prevented. Therefore, it is possible to prevent dust from entering the inside of the second cylindrical portion 813.

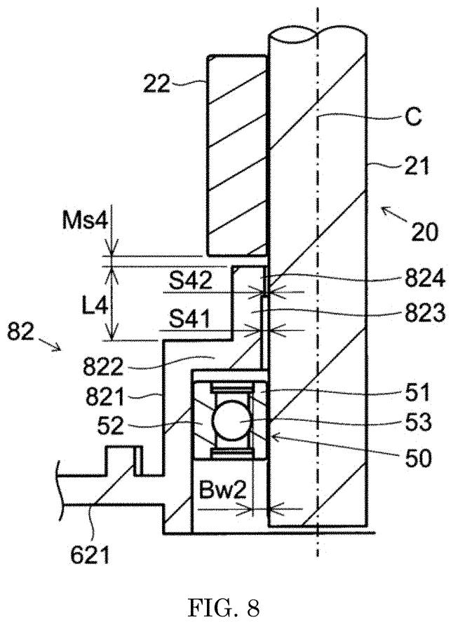

FIG. 8 is a partial longitudinal sectional view showing an area around the second bearing 50 of the motor 1 according to the first modification. The lower bearing holding portion 82 includes a third cylindrical portion 821, a third top plate portion 822, and a fourth cylindrical portion 823. The configurations of the third cylindrical portion 821, the third top plate portion 822, and the fourth cylindrical portion 823 are substantially the same as those of the third cylindrical portion 721, the third top plate portion 722, and the fourth cylindrical portion 723 described above with reference to FIG. 5, and therefore, the description thereof will be omitted.

The lower bearing holding portion 82 further includes a fourth top plate portion 824. That is, the motor housing 60 further includes the fourth top plate portion 824. The fourth top plate portion 824 extends radially inward from the upper end of the fourth cylindrical portion 823. The fourth top plate portion 824 has a disk shape extending in the radial direction about the central axis C. The fourth top plate portion 824 is disposed radially outward of the shaft 21. The fourth top plate portion 824 radially faces the shaft 21. A gap S42 between the fourth top plate portion 824 and the shaft 21 in the radial direction is narrower than the gap S41 between the fourth cylindrical portion 823 and the shaft 21 in the radial direction.

According to the configuration of the first modification, it is not necessary to control the gap S41 between the fourth cylindrical portion 823 and the shaft 21 in the radial direction with high accuracy throughout the entire region of the fourth cylindrical portion 823 in the axial direction. Therefore, dust resistance of the second bearing 50 can be improved by an inexpensive configuration, and productivity of the motor housing 60 can be increased.

The fourth cylindrical portion 823 is disposed below the rotor magnet 22. The fourth cylindrical portion 823 closely faces the rotor magnet 22 in the axial direction. The outer diameter of the fourth cylindrical portion 823 is smaller than the outer diameter of the rotor magnet 22. That is, the radially outer surface of the fourth cylindrical portion 823 is disposed radially inward of the radially outer surface of the rotor magnet 22.

According to the configuration described above, dust moving from top to bottom at the radially outer side of the gap Ms4 between the fourth cylindrical portion 823 and the rotor magnet 22 in the radial direction, for example, is likely to move downward on the radially outer side of the fourth cylindrical portion 823 without moving toward the radially inner side along the top surface of the fourth cylindrical portion 823. That is, intrusion of dust into the gap Ms4 between the fourth cylindrical portion 823 and the rotor magnet 22 in the axial direction can be prevented. Therefore, it is possible to prevent dust from entering the inside of the fourth cylindrical portion 823.

### 1-5. Second Modification of Motor

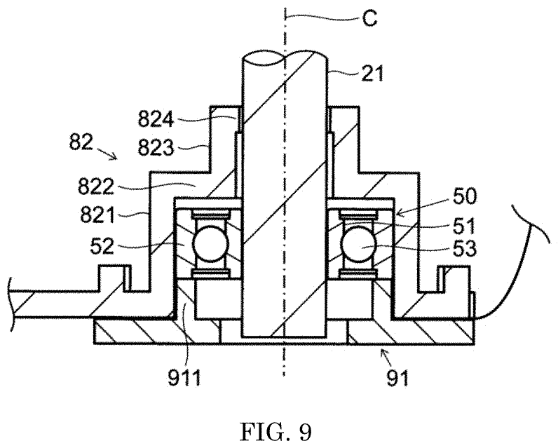

FIG. 9 is a partial longitudinal sectional view showing an area around a second bearing 50 of a motor 1 according to the second modification. The motor 1 according to the second modification includes a lower plate 91.

The lower plate 91 is disposed on the lower surface at the lower end of the motor housing 60. The lower plate 91 has a disk shape extending in the radial direction about the central axis C. That is, the lower plate 91 extends in the direction intersecting the central axis C.

The lower plate 91 includes a protrusion 911. The protrusion 911 is provided on the lower plate 91 at a position near the central axis C and at the central part of the lower plate 91. In the present example embodiment, the protrusion 911 has a tubular shape extending upward from the upper surface of the lower plate 91. The protrusion 911 is positioned radially inward of the third cylindrical portion 821. The protrusion 911 closely faces the third cylindrical portion 821 in the radial direction.

The upper end of the protrusion 911 contacts the lower surface of the outer ring 52 of the second bearing 50. That is, at least a part of the upper surface of the lower plate 91 contacts the lower surface of the outer ring 52 of the second bearing 50. According to this configuration, the second bearing 50 can be fixed by the lower plate 91, and the dust resistance of the second bearing 50 can be improved.

### 2. Configuration of Blower Apparatus

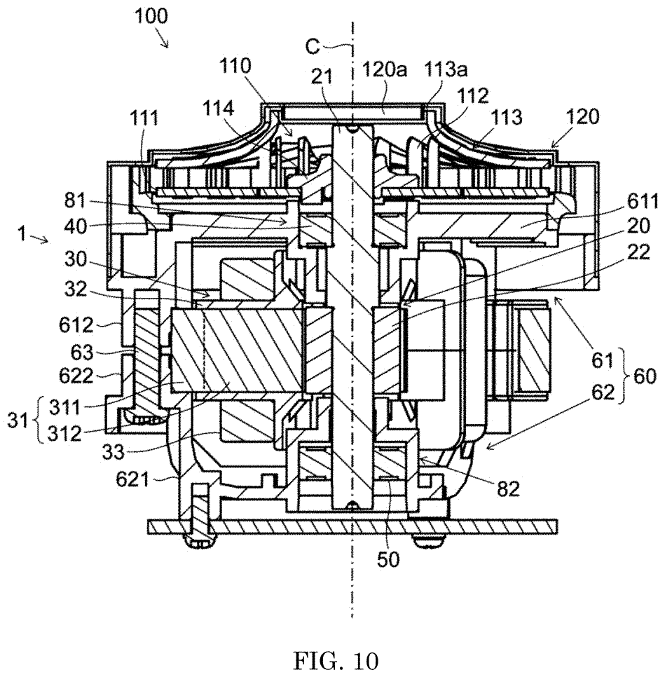

FIG. 10 is a longitudinal sectional view of a blower apparatus 100 according to the example embodiment of the present disclosure. The blower apparatus 100 has the motor 1 having the above-mentioned configuration, and an impeller 110. The blower apparatus 100 also has an impeller cover 120.

### 2-1. Configuration of Impeller

The impeller 110 is disposed radially inward of the impeller cover 120. The impeller 110 is provided above the motor 1 and fixed to the shaft 21. The impeller 110 rotates with the shaft 21 around the central axis C that vertically extends.

The impeller 110 is made of, for example, a metal member. The radial outer edge of the impeller 110 is circular as viewed from the axial direction. The impeller 110 has a base plate 111, a plurality of blades 112, a shroud 113, and a hub 114.

The base plate 111 is disposed at the lower part of the impeller 110. The base plate 111 extends in the radial direction about the central axis C. The base plate 111 is a disk-shaped member. The base plate 111 supports the lower parts of the blades 112.

The blades 112 are disposed on the base plate 111. The impeller 110 has a plurality of blades 112. The plurality of blades 112 are circumferentially arranged on the upper surface of the base plate 111. The lower parts of the plurality of blades 112 are connected to the base plate 111. The upper parts of the plurality of blades 112 are connected to the shroud 113. The blades 112 are plate-shaped members which vertically erect. The blades 112 extend from the inner side to the outer side in the radial direction and curve in the circumferential direction.

The shroud 113 is disposed above the plurality of blades 112. The shroud 113 is an annular plate-like member having a radially inner end and a radially outer end which are circular as viewed in the axial direction. The shroud 113 curves upward from the radially outer end toward the inner side in the radial direction. The shroud 113 has an intake port 113a that is opened vertically. The intake port 113a is formed in the shroud 113 at a position near the central axis C and at the central part of the shroud 113. The shroud 113 supports the upper parts of the blades 112.

The hub 114 is provided on the base plate 111 at a position near the central axis C and at the central part of the base plate 111. The hub 114 is circular as viewed in the axial direction. The shaft 21 vertically penetrates the hub 114 along the central axis C at the central part of the hub 114 and is fixed to the hub 114. Thus, the impeller 110 is fixed to the shaft 21.

### 2-2. Configuration of Impeller Cover

The impeller cover 120 is disposed above the motor 1. The impeller cover 120 covers the impeller 110.

The impeller cover 120 is disposed above the impeller 110. The impeller cover 120 has a cylindrical shape that tapers upward. The radially outer end of the impeller cover 120 is fixed to the radially outer end of the upper housing 61.

The impeller cover 120 has an intake port 120a that is opened vertically. The intake port 120a is formed at the upper end and at the central part of the impeller cover 120 in the radial direction. The lower part of the intake port 120a of the impeller cover 120 radially overlaps the upper part of the intake port 113a of the shroud 113. The outer diameter of the lower part of the intake port 120a of the impeller cover 120 is smaller than the inner diameter of the upper part of the intake port 113a of the shroud 113.

When the impeller 110 is rotationally driven by the motor 1, air is suctioned into the interior of the impeller 110 through the intake port 120a of the impeller cover 120. The air suctioned into the inside of the impeller 110 is guided to the radially outer side by the impeller 110 and is further blown to the radially outer side of the impeller 110. The air blown to the radially outer side of the impeller 110 is guided downward, and is further sent downward on the radially outer side of the motor 1.

The blower apparatus 100 having the above configuration includes the motor 1. Thus, in the blower apparatus 100, the dust resistance of the first bearing 40 and the second bearing 50 of the motor 1 can be improved.

### 3. Configuration of Vacuum Cleaner

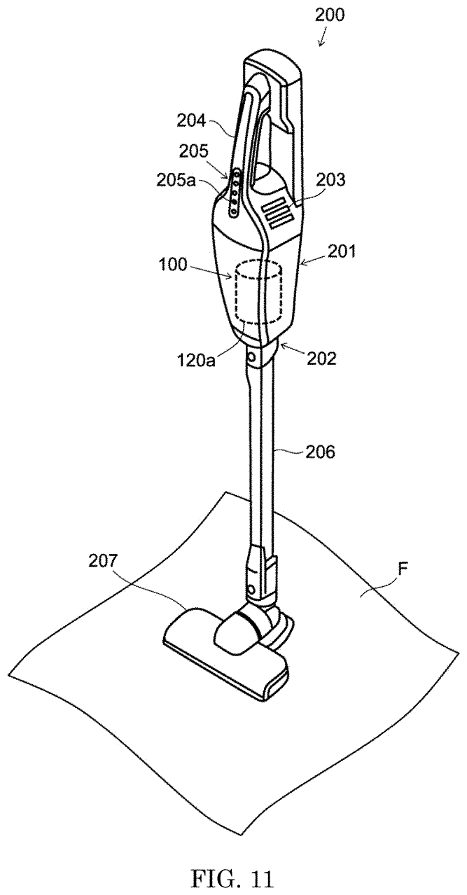

FIG. 11 is a perspective view of a vacuum cleaner 200 according to the example embodiment of the present disclosure. The vacuum cleaner 200 includes the above-described blower apparatus 100. That is, the vacuum cleaner 200 has the motor 1 having the abovementioned configuration. The vacuum cleaner 200 is a so-called stick-type vacuum cleaner. The vacuum cleaner 200 may be an electric vacuum cleaner of any type such as a so-called robot vacuum cleaner, a canister vacuum cleaner, or a handy vacuum cleaner.

The vacuum cleaner 200 has a housing 201 having an intake portion 202 and an exhaust portion 203 on its lower and upper surfaces, respectively. The vacuum cleaner 200 has a battery (not shown) inside the housing 201, and is operated by power supplied from the battery. The vacuum cleaner 200 may have a power cord, and may be operated by power supplied via the power cord connected to a power receptacle provided on a wall or other places of a room.

An air passage (not shown) connecting the intake portion 202 and the exhaust portion 203 is provided inside the housing 201. Inside the air passage, a dust collection unit (not shown), a filter (not shown), and the blower apparatus 100 are arranged in order from the upstream side to the downstream side in the direction of flow of air. In the vacuum cleaner 200, the blower apparatus 100 is disposed such that the intake port 120a faces downward. Dust contained in the air flowing inside the air passage is collected by the filter and accumulated in the dust collection unit which is in the form of a container. Thus, the vacuum cleaner 200 can clean a floor surface F. The dust collection unit and the filter are configured to be removable from the housing 201.

A grip 204 and an operation unit 205 are provided at the top of the housing 201. A user can move the vacuum cleaner 200 by gripping the grip 204. The operation unit 205 has a plurality of buttons 205a. The user can issue operation instructions to the vacuum cleaner 200 and perform operation settings of the vacuum cleaner 200 by operating any of the buttons 205a. For example, the user can issue an instruction to, for example, start the blower apparatus 100, stop the blower apparatus 100, or change the revolution speed, by operating any of the buttons 205a.

The downstream end of a suction pipe 206 extending substantially linearly, that is, the upper end of the suction pipe 206 in FIG. 11, is connected to the intake portion 202. A suction nozzle 207 is detachably attached to the suction pipe 206 at the upstream end of the suction pipe 206, that is, the lower end of the suction pipe 206 in FIG. 11.

The vacuum cleaner 200 having the above configuration has the motor 1. Thus, in the vacuum cleaner 200, the dust resistance of the first bearing 40 and the second bearing 50 of the motor 1 can be improved.

### 4. Others

While example embodiments of the present disclosure have been described above, it will be understood that the scope of the present disclosure is not limited to the above-described example embodiments, and that various modifications are possible without departing from the spirit of the present disclosure. In addition, features of the above-described example embodiments and the modifications thereof may be combined appropriately as desired.

In addition, the blower apparatus 100 may be mounted not only to a vacuum cleaner, but also to various OA devices, medical devices, transport devices, household electric appliances other than vacuum cleaners, and the like.

The present disclosure can be used, for example, in an electric device having a blower apparatus, such as a vacuum cleaner.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotor including a shaft that is disposed along a central axis extending vertically;
a stator disposed to face the rotor in a radial direction;
a first bearing that is disposed above the stator and supports the rotor so as to be rotatable about the central axis with respect to the stator; and
a motor housing that houses at least a portion of the stator; wherein
the motor housing includes:
a first cylindrical portion that is disposed radially outward of the first bearing, extends downward, and has a cylindrical shape;
a first top plate portion that extends radially inward from a lower end of the first cylindrical portion; and
a second cylindrical portion that extends downward from a radially inner end of the first top plate portion and has a cylindrical shape;
the second cylindrical portion includes a radially inner surface positioned such that a gap is defined between the radially inner surface of the second cylindrical portion and a radially outer surface of the shaft in the radial direction.

2. The motor according to claim 1, wherein the gap between the second cylindrical portion and the shaft in the radial direction is narrower than a width of an inner ring of the first bearing in the radial direction.

3. The motor according to claim 1, wherein
the motor housing includes a second top plate portion extending radially inward from a lower end of the second cylindrical portion; and
a gap between the second top plate portion and the shaft in the radial direction is narrower than the gap between the second cylindrical portion and the shaft in the radial direction.

4. The motor according to claim 1, wherein
the rotor includes a rotor magnet fixed to the radially outer surface of the shaft; and
a gap between the lower end of the second cylindrical portion and an upper end of the rotor magnet in an axial direction is shorter than a length of the second cylindrical portion in the axial direction.

5. The motor according to claim 4, wherein a radially outer surface of the second cylindrical portion is disposed radially outward of a radially outer surface of the rotor magnet.

6. The motor according to claim 1, further comprising:
a second bearing that is disposed below the stator and supports the rotor so as to be rotatable about the central axis with respect to the stator; wherein
the motor housing includes:
a third cylindrical portion that is disposed radially outward of the second bearing, extends upward, and has a cylindrical shape;
a third top plate portion that extends radially inward from an upper end of the third cylindrical portion; and
a fourth cylindrical portion that extends upward from a radially inner end of the third top plate portion and has a cylindrical shape;
the fourth cylindrical portion including a radially inner surface positioned such that a gap is defined between the radially inner surface of the fourth cylindrical portion and the radially outer surface of the shaft in the radial direction.

7. The motor according to claim 6, wherein the gap between the fourth cylindrical portion and the shaft in the radial direction is narrower than a width of an inner ring of the second bearing in the radial direction.

8. The motor according to claim 6, wherein
the motor housing includes a fourth top plate portion extending radially inward from an upper end of the fourth cylindrical portion; and
a gap between the fourth top plate portion and the shaft in the radial direction is narrower than the gap between the fourth cylindrical portion and the shaft in the radial direction.

9. The motor according to claim 6, wherein
the rotor includes a rotor magnet fixed to the radially outer surface of the shaft; and
a gap between the upper end of the fourth cylindrical portion and a lower end of the rotor magnet in an axial direction is shorter than a length of the fourth cylindrical portion in the axial direction.

10. The motor according to claim 9, wherein a radially outer surface of the fourth cylindrical portion is disposed radially outward of a radially outer surface of the rotor magnet.

11. The motor according to claim 6, further comprising:
a lower plate disposed on a lower surface at a lower end of the motor housing and extending in a direction intersecting the central axis; wherein
at least a portion of an upper surface of the lower plate contacts a lower surface of an outer ring of the second bearing.

12. A blower apparatus comprising:
the motor according to claim 1; and
an impeller disposed above the motor and fixed to the shaft.

13. A vacuum cleaner comprising:
the blower apparatus according to claim 12.
